(19) United States
(12) Patent Application Publication
(10) Pub. No.: US 2026/0041082 A1
(43) Pub. Date: Feb. 12, 2026

(54) Improved Position Determination for Agricultural Implements

(71) Applicant: Amazonen-Werke H. Dreyer SE & Co. KG, Hasbergen (DE)

(72) Inventor: Frank GROßE PRUES, Bersenbriick (DE)

(73) Assignee: Amazonen-Werke H. Dreyer SE & Co. KG, Hasbergen (DE)

(21) Appl. No.: 19/102,080

(22) PCT Filed: Jan. 18, 2023
(86) PCT No.: PCT/EP2023/051086

§ 371 Date: Feb. 7, 2025

(30) Foreign Application Priority Data
Aug. 18, 2022 (DE) 10 2022 120 893.1

(51) Int. Cl. A01M 7/00

(52) U.S. Cl. CPC A01M 7/0057; A01M 7/0089

(57) ABSTRACT

An agricultural implement for distributing material comprising a support part, a distributor linkage arranged on the support part, the distributor linkage being at least partially rotatable about an axis pointing in the direction of travel of the agricultural implement, a first sensor arrangement for capturing an angle of rotation of the support part, a second sensor arrangement for capturing a rotational speed and/or rotational acceleration of the support part, a third sensor arrangement for capturing a relative angle between the support part and the distributor linkage, and an electronic data processing device configured to detect a relative angle between the support part and the distributor linkage, and an electronic data processing device configured to determine an inclination angle of the distributor linkage with respect to a reference plane on the basis of sensor data from the first sensor arrangement, the second sensor arrangement and the third sensor arrangement.

### CROSS REFERENCE TO RELATED APPLICATIONS

The present application claims priority under 35 U.S.C. § 365 to PCT/EP2023/051086 filed on Jan. 18, 2023 and under 35 U.S.C. § 119 (a) to German Application No. 10 2022 120 893.1 filed on Aug. 18, 2022, both of which are incorporate by reference in their entireties.

### TECHNICAL FIELD

The disclosure relates to an agricultural implement for distributing material, such as fertilizer, plant protection agents or seed, and to a method for determining the angle of inclination of a distributor linkage of an agricultural implement.

### BACKGROUND

Such agricultural implements are generally known, for example as field sprayers. In order to spread the material over a large area and efficiently on the field soil to be treated, the agricultural implements comprise a distributor linkage with several spreading elements, such as spray nozzles. The distributor linkage extends across the direction of travel and can comprise working widths of up to 50 m or more. The distance between the distributor linkage and the ground should remain as constant as possible over the entire working width of the distributor linkage. This means that the distributor linkage is kept as parallel as possible to the ground to be cultivated. It is therefore necessary to capture the distance between the distributor linkage and the ground as accurately as possible during travel.

A device for distributing liquid and/or solid active ingredients with a boom is known from EP 3 007 553 B1, in which a rotational speed of the boom with respect to a reference plane is captured by means of a first sensor arrangement and a rotational position of the boom with respect to the reference plane is captured by means of a second sensor arrangement. These sensors are often arranged directly on the booms of the boom. The rotational position of the boom in relation to the reference plane is calculated by integrating the rotational speed over time, and the current rotational position of the boom in relation to the reference plane is determined by fusing the calculated and measured rotational positions of the boom.

However, the sensor system of this system known from the state of the art is complex and vulnerable. For example, the sensors arranged on the booms are at risk when driving across the field. E.g., the booms can graze plants in the field when there is a lot of vegetation and the sensors can be damaged. Wiring the sensors is also complicated, as the cables have to be routed along the retractable booms. Damage to the cables can therefore occur when the booms are moved. Furthermore, measurement errors can occur with the sensors known from the state of the art due to a translational movement of the distributor linkage. Such a translational movement of the distributor linkage can occur, for example, when the direction of travel changes, for example when turning a curve, in particular when entering and exiting a curve. Such measurement errors can lead to an incorrect determination of the rotational position of the linkage, which has to be corrected by calculation.

### SUMMARY

The object of the disclosure is therefore to provide an improved agricultural implement in which an inclination of a distributor linkage can be precisely determined.

This object can be solved by an agricultural implement for distributing material, such as fertilizer, plant protection agents or seed described herein

The agricultural implement comprises a support part, a distributor linkage arranged on the support part, the distributor linkage being at least partially rotatable about an axis pointing in the direction of travel of the agricultural implement, a first sensor arrangement for capturing an angle of rotation of the support part, a second sensor arrangement for capturing a rotational speed and/or rotational acceleration of the support part, a third sensor arrangement for capturing a relative angle between the support part and the distributor linkage, and an electronic data processing device configured to determine an angle of inclination of the distributor linkage with respect to a reference plane on the basis of sensor data from the first sensor arrangement, the second sensor arrangement and the third sensor arrangement. In particular, the second sensor arrangement comprises at least one sensor that is based on a different measuring principle than a sensor of the first sensor arrangement.

In particular, the agricultural implement may be a field sprayer. It may be a self-propelled field sprayer, a towed field sprayer or a mounted field sprayer.

The support part may be part of a chassis of the agricultural implement. The support part may also be a support frame, for example if the agricultural implement is a mounted field sprayer.

It is possible for the entire distributor linkage to be rotatable about the axis pointing in the direction of travel of the agricultural implement. It is also possible for the distributor linkage to comprise lateral booms, each of which can be rotated and/or pivoted about an axis pointing in the direction of travel of the agricultural implement. In this case, the booms can be rotatable and/or pivotable about a common axis. It is also possible for the booms to each be rotatable and/or pivotable about a separate axis.

Depending on the application and/or requirements, the reference plane may be the agricultural land, in particular an averaged soil profile of the soil on which the agricultural implement is moving, an artificial horizon, i.e. a calculated plane, or a height profile of the crop. Alternatively or additionally, the reference plane may be any predetermined plane in space, in particular one stored in a memory device of the electronic data processing device. Furthermore, the reference plane may alternatively be defined by several points along an arbitrary, in particular curved, contour.

The angle of inclination of the distributor linkage is thus determined on the basis of the determined inclination of the support part and the relative angle between the support part and the distributor linkage. Since the support part is more compact and arranged closer to the center of mass of the agricultural implement compared to the distributor linkage, it is less sensitive to vibrations, especially around an axis pointing in the direction of travel. This means that the inclination of the support part, and thus that of the distributor linkage, can be determined in a robust and improved manner. For example, it is possible to simplify or even eliminate the need for low-pass filtering of the sensor signals to filter out vibrations.

The first sensor arrangement may comprise one or more sensors that directly determine the rotational position of the support part. Such sensors may, for example, be implemented as inclinometers or inclinometers. Alternatively or additionally, the first sensor arrangement may comprise one or more sensors that can capture an acceleration of the support part, in particular a linear acceleration of the support part. It is known that the angles of rotation (the Euler or Cardan angles) of a body in an earth-fixed reference system can be determined based on the relationships between the accelerations in the body-fixed system and the gravitational acceleration. For example, the agricultural implement may move in the x-direction, where the x-direction of the body-fixed system coincides with the x-direction of the earth-fixed reference system. In this case, the distributor linkage extends in the y-direction, and the z-direction corresponds to the vertical axis. In this exemplary case, the angle of rotation α of the support part around the x-axis can be determined by means of the following formula:

$$α = arcsin ( - \frac{{a}_{y}}{g} )$$

Where g is the acceleration due to gravity and a_{y} is the acceleration in the y-direction determined in the fixed-body system. It should be noted that this is only an exemplary possibility for determining the angle of rotation based on the determined accelerations.

It is also possible that the first sensor arrangement comprises one or more sensors configured to determine a distance of the support part from the ground. In particular, the first sensor arrangement may be configured to determine the respective distance of the support part from the ground at two points having a different radial distance from a rotation axis pointing in the direction of travel of the agricultural implement. Based on the respective distances, it may be possible to determine an angle of rotation of the support part about the rotation axis.

In particular, the second sensor arrangement may comprise one or more sensors that determine a rotational speed of the support part. The angle of rotation can be calculated from the rotational speed by integrating the rotational speed over time.

By using the signals from the first and second sensor arrangements, it is possible to correctly determine the rotational position of the support part depending on the situation. For example, the signals from the second sensor arrangement are usually more sensitive to short changes in position over time, such as when driving over a stone or similar. In contrast, the signals from the first sensor arrangement may be more suitable for determining a constant inclination, for example when driving on a slope.

The first sensor arrangement and/or the second sensor arrangement may be arranged directly on the support part. It is also possible that the first sensor arrangement and/or the second sensor arrangement is/are arranged on a part of the distributor linkage which is non-rotatably connected to the support part, for example on a middle part of the distributor linkage.

In the following, the term rotation axis generally refers to an axis around which the body rotates. This can therefore be a physically existing axis or a virtual axis. It should be noted that a rotation axis can also lie outside the body. The term pivot point refers to a point or position on a body through which a rotation axis passes.

The first sensor arrangement and/or the second sensor arrangement may be arranged at, in the immediate vicinity of or at a fixed distance from a rotation axis of the distributor linkage or a boom of the distributor linkage and/or the support part. The fixed distance may be less than 100 cm, in particular less than 50 cm. In particular, the rotation axis may be a vertical rotation axis of the distributor linkage or of a boom of the distributor linkage or of the support part, i.e. a yaw axis. In particular, the vertical axis of rotation may be a virtual axis of rotation about which the distributor linkage or a boom of the distributor linkage and/or the support part describes a rotational movement when the direction of travel is changed, in particular when turning a curve, in particular when entering or exiting a curve.

The arrangement of the first sensor arrangement and/or the second sensor arrangement at or in the immediate vicinity of such a rotation axis may suppress or minimize the influence of translational acceleration components, such as centripetal accelerations, which occur in particular when the direction of travel of the agricultural implement changes, for example when turning a curve.

Due to the arrangement at a fixed distance from such a rotation axis, a computational correction of the output value of the sensor and/or the determined rotational speed and/or rotational position of the linkage, which is falsified by a translational acceleration component, may be performed. In particular when arranging the first sensor arrangement and/or the second sensor arrangement on the support part or a part of the distributor linkage which is connected to the support part in a rotationally fixed manner, the distance between the sensor and the rotation axis remains constant and is not influenced by a change in the position of the linkage.

This allows the rotational speed and/or rotational position of the linkage to be determined more accurately.

The third sensor arrangement may be arranged at a pivot point of the distributor linkage or of a boom of the distributor linkage, in particular a pivot point through which a rotation axis, i.e. a roll axis, extending in the direction of travel passes. It is also possible that the first, second and/or third sensor arrangement is or are arranged on a carrier vehicle if the support part is connected to the carrier vehicle in a rotationally fixed manner.

The arrangement of the sensors on the support part eliminates the need for complex cabling. Furthermore, the sensors can be better protected against damage, for example from collisions with vegetation.

The agricultural implement may further comprise one or more actuators with which the inclination of the distributor linkage can be influenced. In particular, the actuators may be implemented as hydraulically and/or pneumatically operable adjusting cylinders. The electronic data processing device may be configured to control the one or more actuators on the basis of the determined angle of inclination of the distributor linkage with respect to the reference plane. In particular, the electronic data processing device may be configured to control the one or more actuators such that the angle of inclination of the distributor linkage with respect to the reference plane is kept constant or set to a desired value.

The electronic data processing device may be configured to perform a sensor data fusion of the sensor data of the first sensor arrangement and the second sensor arrangement. In such a sensor data fusion, the sensor data of the first and second sensor arrangements complement each other, so that the inclination of the support part can be determined very precisely. In particular, it is possible for the first sensor arrangement to compensate for measurement inaccuracies and/or fluctuations of the second sensor arrangement and vice versa. Such sensor data fusion can be particularly effective if sensors of the first sensor arrangement have a different measuring principle than sensors of the second sensor arrangement.

For example, determining the angle of rotation by means of the first sensor arrangement on the basis of the measured accelerations, as described above, may be computationally simple, but it may also be susceptible to short-term fluctuations. In contrast, determining the angle of rotation by integrating the sensor data of the second sensor arrangement over time can be less susceptible to short-term fluctuations, but it can be subject to uncertainty due to the integration constants that occur. Sensor data fusion can therefore be used to compensate for the disadvantages of one method with the other.

Such a sensor data fusion can, for example, be implemented in such a way that an estimation algorithm is used to obtain an estimate of the true angle of rotation from the angle of rotation determined on the basis of the sensor data of the first sensor arrangement and the angle of rotation determined on the basis of the sensor data of the second sensor arrangement. Such estimation algorithms are known per se. For example, a Kalman filter can be used.

The electronic data processing device may further be configured to determine an inclination angle of the support part with respect to the reference plane based on the sensor data of the first and second sensor arrangements, in particular based on the fused sensor data, and to determine the inclination angle of the distributor linkage based on the determined inclination angle of the support part and the sensor data of the third sensor arrangement. In other words, an inclination angle of the support part to the reference plane can first be determined with high precision as indicated above, before the inclination angle of the distributor linkage is subsequently determined. Thus, the angle of inclination of the distributor linkage can also be determined with correspondingly high precision.

In particular, the electronic data processing device may be configured to perform a temporal integration of the sensor data of the second sensor arrangement. In this case, the integration of the sensor data of the second sensor arrangement may be a single temporal integration if the second sensor arrangement captures a rotation rate of the support part. An angle of rotation of the support part can be calculated by integrating the sensor data of the second sensor arrangement. The integration of the sensor data of the second sensor arrangement may involve a double temporal integration if the second sensor arrangement detects a rotational acceleration of the support part. Furthermore, the electronic data processing device may be configured to perform a sensor data fusion of the sensor data of the first sensor arrangement and the integrated sensor data of the second sensor arrangement, and to perform an addition or subtraction of the fused sensor data and the sensor data of the third sensor arrangement.

In other words, the electronic data processing device may be configured to determine an angle of inclination α of the linkage relative to a reference plane based on the sensor data of the first sensor arrangement, the sensor data of the second sensor arrangement and the sensor data of the third sensor arrangement as follows:

$$α = {α}_{0} + {α}_{r} = 〈 f ( {S}_{1} ) \vert g ( {S}_{2} ) 〉 + h ( {S}_{3} )$$

Here, α₀ denotes the angle of inclination of the support part to the reference plane and αᵣ the relative angle between the linkage and the support part. S₁, S₂ and S₃ denote the sensor data of the first, second and third sensor arrangement respectively. f(S₁) denotes a function that indicates the angle of inclination of the support part based on the sensor data S₍₁₎. Similarly, g(S₂) denotes a function that indicates the angle of inclination of the support part based on the sensor data S₂. The function g(S₂) comprises at least one temporal integration of the sensor data S₂. The notation [symbol] f(S₁)|g(S₂) [symbol] indicates that a sensor data fusion of the sensor data S₁ and S₂ is performed. The function h(S₃) denotes a function that indicates the relative angle of inclination of the distributor linkage relative to the support part based on the sensor data S₃.

The electronic data processing device can furthermore be configured to take into account calibration data of the first and/or second sensor arrangement when determining the inclination angle of the distributor linkage. The data can be stored, for example as a calibration curve, in a memory device of the electronic data processing device. The calibration data can be data that links the inclination angle of the support part with output values of the first and/or second sensor arrangement. The calibration data can be determined by a calibration measurement, for example during or after mounting of the first and/or second sensor arrangement. By taking the calibration data into account, it is possible, for example, to avoid and/or correct measurement errors of the tilt angle due to inaccuracies when mounting the sensors. In this way, a particularly precise determination of the angle of inclination of the support part can be achieved.

The third sensor arrangement may comprise a potentiometer, in particular a rotary or angular potentiometer. Potentiometers are advantageous for measuring the relative angle, as they can be read out with high precision. Potentiometers are also very robust measuring instruments. The electronic data processing device may further be configured to take into account calibration data of the potentiometer when determining the inclination angle of the distributor linkage. The calibration data can be data that links the relative angle of the distributor linkage or a boom of the distributor linkage with output values of the potentiometer. The data can be stored, for example as a calibration curve, in a memory device of the electronic data processing device. In this way, a particularly precise determination of the relative angle between the distributor linkage and the support part can be achieved.

It is further possible that the third sensor arrangement comprises one or more acceleration sensors. In particular, the third sensor arrangement may comprise an acceleration sensor arranged on the distributor linkage and an acceleration sensor arranged on the support part. By comparing the accelerations determined by these sensors, a relative angle between the support part and the distributor linkage can be determined. It is possible that the third sensor arrangement comprises an acceleration sensor of the first sensor arrangement and an acceleration sensor arranged on the distributor linkage for other purposes. In this way, a reduction in the number of sensors required can be achieved.

The first and second sensor arrangements may be configured to determine the angle of rotation and/or the rotational speed of the support part with respect to a first reference plane, and the electronic data processing device may be configured to determine the angle of inclination of the distributor linkage with respect to a second reference plane. In particular, the first and second reference planes may be different planes. For example, an angle of inclination to the ground may be determined for the support part, and an angle of inclination of the distributor linkage to the artificial horizon can be determined. This can be advantageous, for example, if it is technically easy to determine the inclination of the support part to the ground, but it is desired that the distributor linkage is guided at a constant distance from the artificial horizon.

In this case, it is possible that additional data linking the first and second reference planes are stored in a memory device of the electronic data processing device.

The first sensor arrangement and/or the second sensor arrangement can be part of an inertial measurement unit, IMU. Such IMUs are robust and compact measuring units that offer the possibility of capturing various kinematic data, in particular rotation rates and accelerations, in several degrees of freedom by means of inertial sensors, for example, acceleration and/or rotation rate sensors. In particular, the first sensor arrangement and the second sensor arrangement can be part of a single IMU, so that a compact design of the sensor system is possible. However, it is also possible for the first sensor arrangement and the second sensor arrangement to be parts of different IMUs. For example, it is possible to use the acceleration sensors of an IMU to determine the angle of rotation of the support part via a relationship of the measured acceleration with the acceleration due to gravity, as described above. The angular rate sensors can be used to determine the angle of rotation via temporal integration.

In an alternative embodiment, it is possible that the first sensor arrangement and/or the second sensor arrangement each comprise one or more IMUs. For example, it is possible that the first sensor arrangement comprises a first IMU arranged at a first location of the support part and a second IMU arranged at a second location of the support part. By evaluating, in particular fusing, the sensor data of the first and second IMU, the angle of rotation of the support part can be determined with high precision. Similarly, the second sensor arrangement can comprise several IMUs. It is also possible for several IMUs to be part of both the first and the second sensor arrangement. For example, the acceleration sensors of the IMUs can be used to determine the angle of rotation and the rotation rate sensors of the IMUs can be used to determine the rotational speed.

In the event that the first sensor arrangement can capture an acceleration along at least two mutually orthogonal axes and the second sensor arrangement can capture a rotation rate about at least two mutually orthogonal axes, it is possible for the electronic data processing device to be configured to determine a rotation rate about any further rotation axis on the basis of the determined accelerations and rotation rates. This is possible as long as a respective rotation axis of the second sensor arrangement runs essentially parallel to a respective acceleration axis of the first sensor arrangement. The electronic data processing device can make use of known trigonometric transformations and coordinate transformations. This can simplify the calculation of the rotation rate about any axis.

In particular, the first sensor arrangement may capture a respective acceleration along at least three mutually orthogonal axes and the second sensor arrangement can capture a respective rotation rate about three mutually orthogonal axes, wherein each respective rotation axis of the second sensor arrangement runs essentially parallel to one respective acceleration axis of the first sensor arrangement. Such a configuration enables the rate of rotation about any axis to be determined accurately, irrespective of the orientation of the first and second sensor arrangements relative to the support part.

The distributor linkage may comprise a central frame, which is connected to the agricultural implement, in particular the support part, in a rotationally fixed manner, and two lateral booms connected to the central frame. The booms can each be pivotable about an axis pointing in the direction of travel of the agricultural implement.

In this case, the third sensor arrangement can be configured to determine a relative angle between a first of the lateral booms and the support part, to determine a relative angle between the second of the lateral booms and the support part, and to determine an inclination angle of the first boom with respect to a reference plane and/or an inclination angle of the second boom with respect to a reference plane on the basis of sensor data from the first sensor arrangement, the second sensor arrangement and the third sensor arrangement. Thus, even for a distributor linkage in which both booms can be pivoted and/or angled independently of each other, the respective angle of inclination of the booms can be determined in a precise and robust manner.

In particular, the third sensor arrangement may comprise a sensor, in particular a potentiometer, for each of the two booms. In particular, these sensors can be arranged at the respective pivot points of the booms. Corresponding calibration data of the potentiometers can also be stored here, for example in a memory unit of an electronic data processing device of the agricultural machine.

Analogous to the above, the electronic data processing device can be configured to determine the angle of inclination α₁ of the first boom and α₄ of the second boom relative to the reference plane based on the sensor data of the first sensor arrangement, the sensor data of the second sensor arrangement, and the sensor data of the third sensor arrangement as follows:

$${α}_{1} = {α}_{0} + {α}_{2} = 〈 f ( {S}_{1} ) \vert g ( {S}_{2} ) 〉 + {h}_{1} ( {S}_{3} )$$

$${α}_{4} = {α}_{0} + {α}_{3} = 〈 f ( {S}_{1} ) \vert g ( {S}_{2} ) 〉 + {h}_{2} ( {S}_{4} )$$

Here, α₀ again denotes the angle of inclination of the support part to the reference plane. S₁ and S₂ denote the sensor data of the first and second sensor arrangement respectively. S₃ and S₄ each denote the sensor data of the third sensor arrangement, which relate to the relative angle between the first boom and the support part and the relative angle between the second boom and the support part. f(S₁) denotes a function that indicates the angle of inclination of the support part based on the sensor data S₍₁₎. Similarly, g(S₂) denotes a function that indicates the angle of inclination of the support part based on the sensor data S₂. The function g(S₂) comprises at least one temporal integration of the sensor data S₂. The notation [symbol] f(S₁)|g(S₂) [symbol] indicates that a sensor data fusion of the sensor data S₁ and S₂ is performed. The function h₁(S₃) denotes a function that indicates the relative angle of inclination of the first boom relative to the support part based on the sensor data S₍₃₎. Similarly, the function h₂(S₄) denotes a function that specifies the relative angle of inclination of the second boom relative to the support part based on the sensor data S₄.

The electronic data processing device may be configured to determine an angle of inclination of the first boom with respect to a third reference plane and to determine the angle of inclination of the second boom with respect to a fourth reference plane, wherein the third and fourth reference planes are different planes. Thus, it is possible that the angle of inclination of the first boom is determined with respect to the ground, while the angle of inclination of the second boom is determined with respect to an artificial horizon. This can be advantageous if, for example, one boom is guided along a slope while the other boom is guided over a flat surface.

The disclosure further provides a method for determining the angle of inclination of a distributor linkage of an agricultural implement with respect to a reference plane, wherein the agricultural implement may comprise in particular one or more of the above-mentioned features. The method comprises:
Determining an angle of rotation of a support part of the agricultural implement;
Determining a rotational speed and/or rotational acceleration of the support part;
Determining a relative angle between the distributor linkage and the support part; and
Determining the angle of inclination of the distributor linkage with respect to a reference plane on the basis of the determined angle of rotation of the support part, the determined rotational speed of the support part and the determined relative angle, and/or
Determining the inclination angle of the distributor linkage based on the determined angle of rotation of the support part, the determined rotational acceleration of the support part and the determined relative angle.

As mentioned above, by using the angle of rotation of the support part, the rotational speed and/or acceleration and the relative angle between the support part and the distributor linkage, the angle of inclination of the distributor linkage can be determined in a precise and robust manner.

The method may further comprise performing a sensor data fusion of sensor data corresponding to the angle of rotation of the support part and sensor data corresponding to the determined rotational speed and/or the determined rotational acceleration. The sensor data may be captured by first and second sensor arrangements of the agricultural implement, respectively.

The method may further comprise:
Determining an inclination angle of the support part based on the determined angle of rotation of the support part and the determined rotational speed and/or the determined rotational acceleration, in particular based on fused sensor data; and
Determining the inclination angle of the distributor linkage based on the determined inclination angle of the support part and the determined relative angle.

It is possible for the angle of rotation and/or the rotational speed of the support part to be determined with respect to a first reference plane and for the angle of inclination of the distributor linkage to be determined with respect to a second reference plane, the first and second reference planes being different planes.

The method may further comprise:
Temporal integration of sensor data corresponding to the determining rotational speed and/or the determining rotational acceleration;
Sensor data fusion of sensor data corresponding to the angle of rotation of the support part and the integrated sensor data; and
Addition or subtraction of the fused sensor data with sensor data corresponding to the relative angle between the support part and the distributor linkage.

The distributor linkage may comprise a central frame that is non-rotatably connected to the agricultural implement, in particular the support part, and two lateral booms connected to the central frame. In this case, the method may further comprise:
Determining a relative angle between a first of the lateral booms and the support part;
Determining a relative angle between the second of the lateral booms and the support part; and
Determining an angle of inclination of the first boom with respect to a reference plane and/or an angle of inclination of the second boom with respect to a reference plane based on the determined angle of rotation of the support part, the determined rotational speed of the support part and the respective determined relative angles, and/or
Determining an angle of inclination of the first boom with respect to a reference plane and/or an angle of inclination of the second boom with respect to a reference plane based on the determined angle of rotation of the support part, the determined rotational acceleration of the support part and the respective determined relative angles.

The angle of inclination of the first boom may be determined with respect to a third reference plane and the angle of inclination of the second boom may be determined with respect to a fourth reference plane, the third and fourth reference planes being different planes.

### BRIEF DESCRIPTION OF THE DRAWINGS

Further features and advantages of the disclosure are explained below with reference to the exemplary figures.

FIG. 1 shows a schematic perspective view of an agricultural implement;

FIG. 2 shows a schematic view of a linkage of an agricultural implement;

FIG. 3 shows a schematic view of a linkage of an agricultural implement; and

FIG. 4 shows a schematic top view of an agricultural implement.

### DETAILED DESCRIPTION

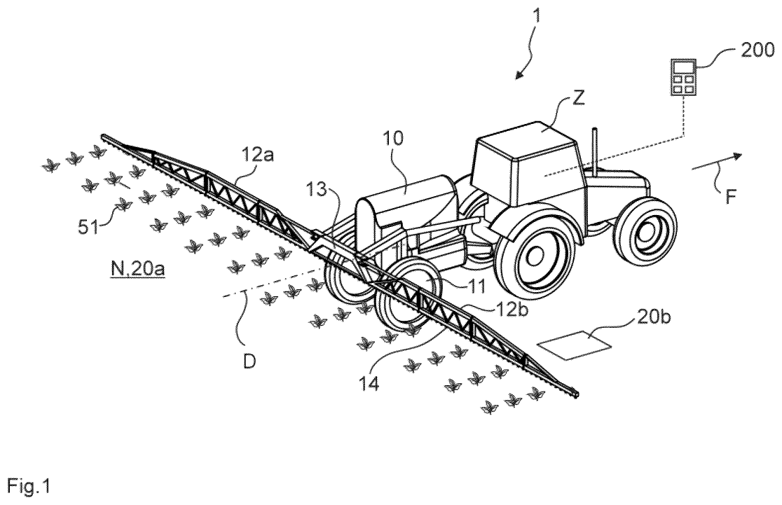

FIG. 1 schematically shows a perspective view of an agricultural implement 1, which is configured as a field sprayer for distributing material, in particular spray agent, on an agricultural utilizable area N and/or its crop 51. In the embodiment shown, the agricultural implement 1 comprises a tractor Z that moves in a direction of travel F. It can be seen that the agricultural implement 1 comprises a linkage 12, a storage container 10, and a support part 11 configured as a chassis. The material to be applied, in particular plant protection agent and/or fertilizer, is stored in the storage container 10 and can be distributed via a delivery system, not shown, to several application elements implemented as spray nozzles 14, which are arranged next to each other on the boom 12, and can be applied via these.

The linkage 12 comprises a left-hand boom 12a and a right-hand boom 12b, each extending from a central frame 13 to the left and to the right. The linkage 12 can be pivoted and/or bent or angled about a rotation axis D. In particular, it is possible that the booms 12a and 12b can each be pivoted and/or angled about the rotation axis D. FIG. 1 shows a state in which the booms 12a and 12b are fully extended.

The agricultural implement 1 further comprises an electronic data processing device 200 configured to determine an inclination of the linkage 12, in particular an inclination of the boom 12a and/or the boom 12b, with respect to a reference plane 20a, 20b. The reference plane 20a, 20b can be a plane running along an artificial horizon, a ground profile and/or any defined plane in space. It is possible for the electronic data processing device 200 to determine the inclination for the booms 12a, 12b with respect to different reference planes 20a, 20b. In the embodiment shown, the inclination with respect to the soil profile N of the agricultural area is determined as the first reference plane 20a for the left-hand boom 12a and the inclination with respect to an artificial horizon is determined as the second reference plane 20b for the right-hand boom 12b. Alternatively or in addition to the embodiment 20 shown, the angle of inclination of the booms 12a, 12b with respect to the same reference plane 20a, 20b can be determined.

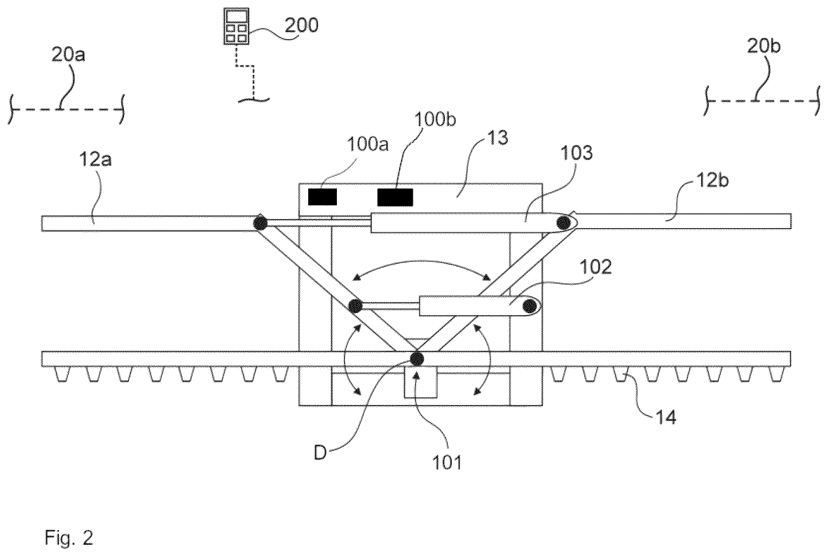

FIG. 2 shows a first embodiment of a linkage 12 of an agricultural implement in a detailed view. In particular, the agricultural implement may be the implement shown in FIG. 1. In the embodiment shown, the booms 12a, 12b are arranged to pivot about a common rotation axis D on the central frame 13. The central frame 13 is non-rotatably connected to a support part of the agricultural implement not shown in FIG. 2.

A first sensor arrangement 100a is arranged on the central frame 13, which is configured to detect an angle of inclination of the central frame 13. In the embodiment shown, the first sensor arrangement 100a comprises an inclinometer. Furthermore, a second sensor arrangement 100b is arranged on the central frame 13, which is configured to detect a rotational speed and/or rotational acceleration of the central frame 13. In the embodiment shown, the second sensor arrangement 100b comprises an IMU.

The electronic data processing device 200 is configured to receive sensor data from the first sensor arrangement 100a and the second sensor arrangement 100b, and to determine an angle of inclination of the central frame 13 relative to the reference plane 20a and/or the reference plane 20b on the basis of the received sensor data. In particular, the electronic data processing device 200 is configured to perform a sensor data fusion of the sensor data of the first sensor arrangement 100a and the second sensor arrangement 100b and to determine the inclination angle of the central frame 13, and thus of the support part 11, to the reference plane 20a and/or the reference plane 20b on the basis of the fused sensor data. Here, the electronic data processing device 200 is configured to perform a single or double temporal integration of the data of the second sensor arrangement 100b, depending on whether a rotational speed or a rotational acceleration of the central frame 13 is captured. It is also possible that both a rotational speed and a rotational acceleration of the central frame 13 are captured by the second sensor arrangement 100b. In this case, the electronic data processing device 200 may be configured to perform a single temporal integration of the rotational speed and a double temporal integration of the rotational acceleration.

As an alternative to the embodiment described, it is also possible that both the first sensor arrangement 100a and the second sensor arrangement 100b comprise an IMU, in particular the same IMU. In this case, the electronic data processing device 200 may, for example, be configured to determine an inclination angle based on acceleration data of the first sensor arrangement 100a, to perform a simple temporal integration of rotational speed data of the second sensor arrangement 100b, and to subsequently fuse these data.

Furthermore, it can be seen in FIG. 2 that the agricultural device 1 comprises a third sensor arrangement 101 arranged on the rotation axis D. The third sensor arrangement 101 comprises an angle-detecting sensor, in particular a potentiometer, which is set up to capture an inclination caused by a pivoting of the linkage 12. The electronic data processing device 200 is configured to determine an inclination of the linkage 12 relative to the reference plane 20a and/or the reference plane 20b on the basis of the data of the third sensor arrangement 101 and the fused data of the first sensor arrangement 100a and the second sensor arrangement 100b. Here, it is possible for the electronic data processing device 200 to access calibration data that link the measured values of the third sensor arrangement 101 with an inclination of the linkage 12 with respect to the support part 11. This calibration data can be stored in a memory unit (not shown) of the electronic data processing device 200.

In other words, the electronic data processing device 200 is configured to determine an inclination angle α of the linkage 12 with respect to the reference plane 20a and/or the reference plane 20b based on the sensor data S₁ of the first sensor arrangement 100a, the sensor data S₂ of the second sensor arrangement 100b and the sensor data S₃ of the third sensor arrangement 101 as follows:

$$α = {α}_{0} + {α}_{r} = 〈 f ( {S}_{1} ) \vert g ( {S}_{2} ) 〉 + h ( {S}_{3} )$$

Here, α₀ denotes the angle of inclination of the support part 11 relative to the reference plane 20a and/or the reference plane 20b and r denotes the relative angle between the linkage 12 and the support part 11. f(S₁) denotes a function that indicates the angle of inclination of the support part 11 based on the sensor data S₍₁₎. Similarly, g(S₂) denotes a function that indicates the angle of inclination of the support part 11 based on the sensor data S₂. The function g(S₂) comprises at least one temporal integration of the sensor data S₂. The notation (f(S₁)|g(S₂)) indicates that a sensor data fusion of the sensor data S₁ and S₂ is performed. The function h (S₃) denotes a function that indicates the relative angle of inclination of the linkage 12 relative to the support part 11 based on the sensor data S₃.

FIG. 2 also shows that the boom 12a is connected to the central frame 13 by means of a first actuator 102. In addition, a second actuator 103 connects the boom 12a to the boom 12b. The first actuator 102 and/or second actuator 103 can be, in particular, hydraulically and/or pneumatically operable actuating cylinders. By activating the actuators 102 and 103 accordingly, it is possible to adjust the position of the booms 12a and 12b individually.

If the retraction or extension of the second actuator 103 is locked, the booms 12a and 12b can be pivoted together and/or dependent on each other via the first actuator 102. In this case, a pivoting and/or angular change of the respective booms 12a, 12b towards or away from each other is blocked by second actuator 103. In other words, in this case the entire boom is rotated in the same direction about the rotation axis D.

If, on the other hand, only the boom 12a is to be angled, the first actuator 102 can be retracted in this embodiment. In order to prevent the resulting movement of the first boom 12a from being transferred to the second boom 12b, the second actuator 103 can also be retracted. This can be done, for example, by actively controlling the second actuator 103. In other words, in this case only a rotation of the first boom 12a about the rotation axis D takes place.

If only the second boom 12b is to be angled, the second actuator 103 can be retracted in this embodiment. The length of the first actuator 102, on the other hand, can be maintained. This can be done, for example, by actively controlling the first actuator 102, but also by locking the first actuator 102, for example. In this case, the left boom 12a is thus fixed by means of the first actuator 102, and only a rotation of the second boom 12b about the rotation axis D takes place.

Alternatively or in addition to the embodiment described, the first actuator 102 and/or the second actuator 103 can also be implemented as at least one electric drive, in particular a motor with or without a mechanical gearbox.

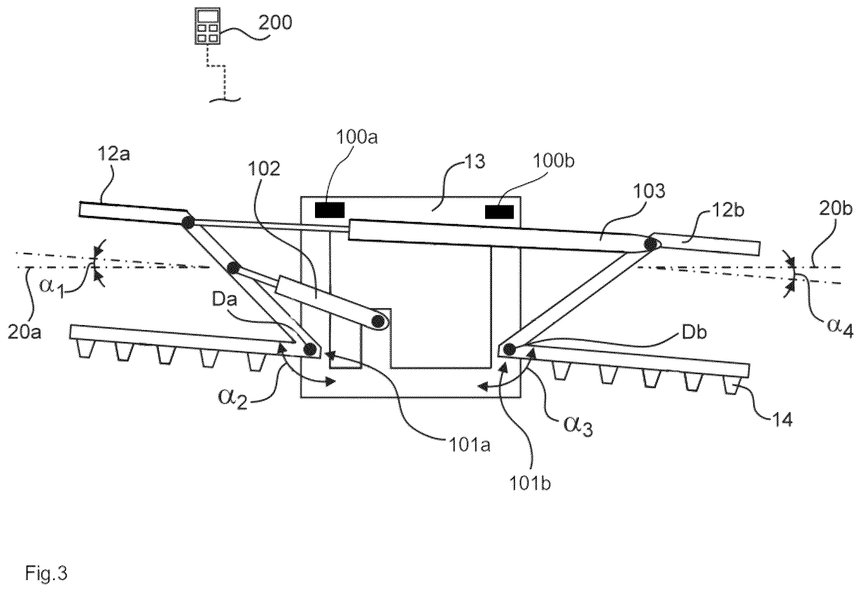

FIG. 3 shows a second embodiment of a linkage 12 of an agricultural implement in a detailed view. The agricultural implement may in particular be the implement shown in FIG. 1.

The embodiment shown in FIG. 3 differs from the embodiment shown in FIG. 2 in that the booms 12a, 12b are each arranged on the central frame 13 so as to be pivotable about their own rotation axes Da, Db. Furthermore, the third sensor arrangement 101 comprises a first angle-detecting sensor 101a, in particular a potentiometer, which is arranged on the rotation axis Da, and a second angle-detecting sensor 101b, in particular a potentiometer, which is arranged on the rotation axis Db. FIG. 3 shows that the boom 12a is inclined by a relative angle α₂ with respect to the central frame 13. The boom 12b is inclined relative to the central frame 13 by the relative angle α₍₃₎.

Analogous to the above, the inclination angles di and @4 of the booms 12a and 12b to the reference plane 20a and/or the reference plane 20b can be determined by the electronic data processing device based on the sensor data S₁ of the first sensor arrangement 100a, the sensor data S₂ of the second sensor arrangement 100b, the sensor data S₃ of the sensor 101a and the sensor data S₄ of the sensor 101b as follows:

$${α}_{1} = {α}_{0} + {α}_{2} = 〈 f ( {S}_{1} ) \vert g ( {S}_{2} ) 〉 + {h}_{1} ( {S}_{3} )$$

$${α}_{4} = {α}_{0} + {α}_{3} = 〈 f ( {S}_{1} ) \vert g ( {S}_{2} ) 〉 + {h}_{2} ( {S}_{4} )$$

Here, α₀ again denotes the angle of inclination of the support part 11 relative to the reference plane 20a and/or the reference plane 20b. f(S₁) denotes a function that indicates the angle of inclination of the support part 11 based on the sensor data S₍₁₎. Similarly, g(S₂) denotes a function that indicates the angle of inclination of the support part 11 based on the sensor data S₂. The function g(S₂) comprises at least one temporal integration of the sensor data S₂. The notation (f(S₁)|g(S₂)>indicates that a sensor data fusion of the sensor data S₁ and S₂ is performed. The function h₁(S₃) denotes a function that indicates the relative angle of inclination of the boom 12a relative to the support part 11 based on the sensor data S₃. Similarly, the function h₂(S₄) denotes a function that specifies the relative inclination angle of the boom 12b relative to the support part 11 based on the sensor data S₄.

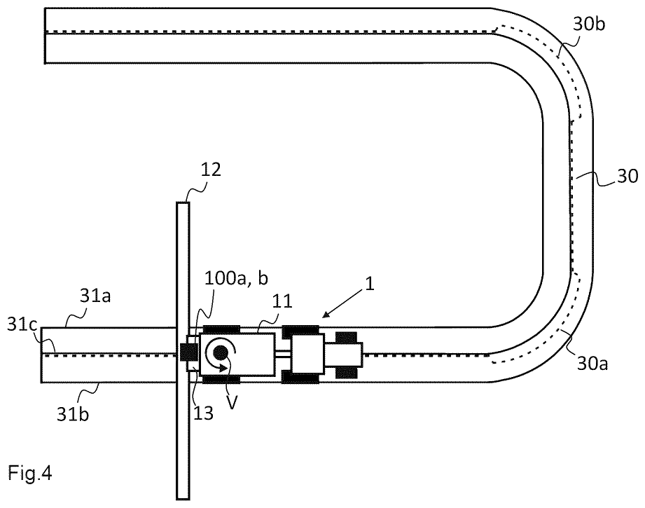

FIG. 4 shows a top view of an agricultural implement 1. FIG. 4 shows the support part 11, the central frame 13, the distributor linkage 12, and the position of the first sensor arrangement 100a and the second sensor arrangement 100b. The solid lines 31a, 31b and 31c schematically indicate tracks that describe the rear wheels and the center point of the agricultural implement 1 when passing through the curve shown. In the embodiment shown, it is possible that the support part is provided with a corresponding steering system to maintain the track.

The dashed line 30 schematically indicates a track that is described by the position of the first sensor arrangement 100a and the second sensor arrangement 100b, or would be described if the sensor arrangements were not firmly arranged on the support part 11. It can be seen that the position of the first sensor arrangement 100a and the second sensor arrangement 100b in the areas 30a and 30b deviates from the track of the center point 31c. This is due to the fact that when entering or leaving the curve shown, a rotation of the central frame or the distributor linkage around the vertical axis V takes place. In the areas 30a and 30b, a translational acceleration (the centripetal acceleration) thus acts on the first sensor arrangement 100a and the second sensor arrangement 100b. It should be noted that such an acceleration during turning a curve naturally also acts on the first sensor arrangement 100a and the second sensor arrangement 100b if the sensor arrangements are arranged fixedly on the support part.

In order to minimize the influence of this acceleration on determining the angle of inclination of the distributor linkage 12 as described above, the distance between the first sensor arrangement 100a and the second sensor arrangement 100b and the axis V is less than 100 cm, preferably less than 50 cm.

It is understood that the features mentioned in the embodiments described above are not limited to these particular combinations and are also possible in any other combinations. Furthermore, it is understood that the geometries shown in the figures are only exemplary and are also possible in any other configuration.

1. An agricultural implement for distributing material, such as fertilizer, plant protection agents or seed, comprising:
a support part;
a distributor linkage arranged on the support part, wherein the distributor linkage is at least partially rotatable about an axis pointing in the direction of travel of the agricultural implement;
a first sensor arrangement for capturing an angle of rotation of the support part;
a second sensor arrangement for capturing a rotational speed and/or rotational acceleration of the support part;
a third sensor arrangement for capturing a relative angle between the support part; and the distributor linkage; and
an electronic data processing device configured to determine an inclination angle of the distributor linkage with respect to a reference plane on the basis of sensor data from the first sensor arrangement, the second sensor arrangement and the third sensor arrangement.

2. The agricultural implement-according to claim 1, wherein the first sensor arrangement and/or the second sensor arrangement and/or the third sensor arrangement is arranged on the support part.

3. The agricultural implement according to claim 1, wherein the first sensor arrangement and/or the second sensor arrangement are arranged on, in the immediate vicinity of, or at a fixed distance from, an axis of rotation of the distributor linkage or of a boom of the distributor linkage and/or of the support part.

4. The agricultural implement according to claim 1, wherein the electronic data processing device is configured to
perform a sensor data fusion of the sensor data of the first sensor arrangement and the second sensor arrangement.

5. The agricultural implement according to claim 1, wherein the electronic data processing device is configured to:
determine an angle of inclination of the support part with respect to the reference plane on the basis of the sensor data of the first and the second sensor arrangement; and
determine the inclination angle of the distributor linkage on the basis of the determined inclination angle of the support part and the sensor data of the third sensor arrangement.

6. The agricultural implement according to claim 1, wherein the electronic data processing device is configured to
perform a temporal integration of the sensor data of the second sensor arrangement;
to perform a sensor data fusion of the sensor data of the first sensor arrangement and the integrated sensor data of the second sensor arrangement (100b); and
perform an addition or subtraction of the fused sensor data and the sensor data of the third sensor arrangement.

7. The agricultural implement according to claim 1, wherein the third sensor arrangement comprises a potentiometer, wherein the electronic data processing device is configured to take into account calibration data of the potentiometer when determining the inclination angle of the distributor linkage.

8. The agricultural implement according to claim 1, wherein the first sensor arrangement and/or the second sensor arrangement is part of an inertial measurement unit.

9. The agricultural implement according to claim 1, wherein the distributor linkage comprises:
a central frame, which is non-rotatably connected to the agricultural implement; and
two lateral booms connected to the central frame, wherein the booms are each pivotable about an axis pointing in the direction of travel of the agricultural implement.

10. The agricultural implement according to claim 9, wherein the third sensor arrangement is configured to:
determine a relative angle between a first of the lateral booms and the support part;
determine a relative angle between the second of the lateral booms and the support part; and
determine an inclination angle of the first boom with respect to a reference plane and/or an inclination angle of the second boom with respect to a reference plane on the basis of sensor data from the first sensor arrangement, the second sensor arrangement and the third sensor arrangement.

11. A method for determining the angle of inclination of a distributor linkage of an agricultural implement with respect to a reference plane of the agricultural implement according to claim 1, comprising:
determining an angle of rotation of a support part of the agricultural implement;
determining a rotational speed and/or rotational acceleration of the support part;
determining a relative angle between the distributor linkage and the support part; and
determining the angle of inclination of the distributor linkage with respect to a reference plane on the basis of the determined angle of rotation of the support part, the determined rotational speed of the support part and the determined relative angle, and/or
determining the angle of inclination of the distributor linkage based on the determined angle of rotation of the support part, the determined rotational acceleration of the support part and the determined relative angle.

12. The method according to claim 11, further comprising:
performing sensor data fusion of sensor data corresponding to the angle of rotation of the support part and sensor data corresponding to the determined rotational speed and/or the determined rotational acceleration.

13. The method according to claim 11, further comprising:
determining an inclination angle of the support part based on the determined angle of rotation of the support part and the determined rotational speed and/or the determined rotational acceleration; and
determining the angle of inclination of the distributor linkage based on the determined angle of inclination of the support part and the determined relative angle.

14. The method according to claim 11, wherein the method further comprises:
integration of sensor data corresponding to the determined rotational speed and/or the determined rotational acceleration;
sensor data fusion of sensor data corresponding to the angle of rotation of the support part and the integrated sensor data; and
addition or subtraction of the fused sensor data with sensor data corresponding to the relative angle between the support part and the distributor linkage.

15. The method according to claim 11, wherein the distributor linkage comprises a central frame, which is non-rotatably connected to the agricultural implement, and two lateral booms connected to the central frame, the method further comprising:
determining a relative angle between a first of the lateral booms and the support part;
determining a relative angle between the second of the lateral booms and the support part; and
determining an angle of inclination of the first boom with respect to a reference plane and/or an angle of inclination of the second boom with respect to a reference plane on the basis of the determined angle of rotation of the support part, the determined rotational speed of the support part and the respective determined relative angles, and/or
determining an angle of inclination of the first boom with respect to a reference plane and/or an angle of inclination of the second boom with respect to a reference plane on the basis of the determined angle of rotation of the support part, the determined rotational acceleration of the support part and the respective determined relative angles.

16. The method according to claim 15,
wherein the angle of inclination of the first boom is determined with respect to a third reference plane,
wherein the angle of inclination of the second boom is determined with respect to a fourth reference plane, and,
wherein the third and fourth reference planes are different planes.

17. The agricultural implement according to claim 3, wherein the axis of rotation is a vertical axis of rotation.

18. The agricultural implement according to claim 5, wherein the angle of inclination of the support part is determined on the basis of the fused sensor data.

19. The method according to claim 13, wherein the inclination angle of the support part is determined based on fused sensor data.
